(19) United States
(12) Patent Application Publication
(10) Pub. No.: US 2020/0272529 A1
(43) Pub. Date: Aug. 27, 2020

(54) ELECTRONIC DEVICE CONNECTING TWO APPLICATIONS

(71) Applicant: PANASONIC INTELLECTUAL PROPERTY MANAGEMENT CO., LTD., Osaka (JP)

(72) Inventors: Kenta SUZUKI, Kanagawa (JP); Shingo SAKAMOTO, Kanagawa (JP); Daisuke YAMAMOTO, Kanagawa (JP); Shunji TSUTSUMI, Kanagawa (JP)

(73) Assignee: PANASONIC INTELLECTUAL PROPERTY MANAGEMENT CO., LTD., Osaka (JP)

(21) Appl. No.: 16/801,855

(22) Filed: Feb. 26, 2020

(30) Foreign Application Priority Data
Feb. 27, 2019 (JP) 2019-034462
Feb. 27, 2019 (JP) 2019-034463

(51) Int. Cl. G06F 9/54; G06F 8/65; B60R 16/023

(52) U.S. Cl. CPC G06F 9/541; B60R 16/023; G06F 9/542; G06F 8/65

(57) ABSTRACT

A receiving unit receives an execution request for an internal application from an external device. A determining unit determines whether the external device that has transmitted the execution request is set as a communication target of the internal application for which the execution request has been received. If it has been determined that the external device is set as the communication target, a verifying unit verifies a version of the external application executed in the external device. If the verified version is no earlier than a threshold, an execution controlling unit executes the internal application. If the verified version is older than the threshold, an informing unit issues a warning.

### BACKGROUND

### 1. Field

The present disclosure relates to connection technology and relates in particular to an electronic device that connects two applications.

### 2. Description of the Related Art

An electronic device, such as a navigation device, connects to an external device, such as a mobile phone or a portable music player, and provides various functions in cooperation with the external device. In this case, the electronic device determines whether the external device that has transmitted an execution request for an application is registered, and if the external device is registered, the electronic device connects to the external device to execute the application (see, for example, patent document 1).

[patent document 1] JP2015-123891

There is a demand for an electronic device that is easier to operate for its user.

### SUMMARY

In view of the above, the present disclosure is directed to providing a technology that makes an electronic device easier to operate for its user.

To address the shortcomings described above, an electronic device according to one aspect of the present disclosure is capable of executing an internal application that operates in cooperation with an external application executed in an external device, and the electronic device includes: a receiving unit that receives an execution request for the internal application from the external device; a determining unit that determines whether the external device that has transmitted the execution request is set as a communication target of the internal application for which the receiving unit has received the execution request; a verifying unit that verifies aversion of the external application executed in the external device if the determining unit has determined that the external device is set as the communication target; an execution controlling unit that executes the internal application if the version verified by the verifying unit is no earlier than a threshold; and an informing unit that issues a warning if the version verified by the verifying unit is older than the threshold.

Another aspect of the present disclosure provides also an electronic device. The electronic device is capable of executing an internal application that operates in cooperation with an external application executed in an external device, and the electronic device includes: a receiving unit that receives an execution request for the internal application from a first external device; a determining unit that determines whether the first external device that has transmitted the execution request is set as a communication target of the internal application for which the receiving unit has received the execution request; a verifying unit that verifies with a second external device set as the communication target whether the electronic device may communicate with the first external device if the determining unit has determined that the first external device is not set as the communication target; and an execution controlling unit that executes the internal application if the verifying unit has verified that the electronic device may communicate with the first external device.

Yet another aspect of the present disclosure provides a processing method. This is a processing method to be performed in an electronic device capable of executing an internal application that operates in cooperation with an external application executed in an external device, and the processing method includes: receiving an execution request for the internal application from the external device; determining whether the external device that has transmitted the execution request is set as a communication target of the internal application for which the execution request has been received; verifying a version of the external application executed in the external device if it has been determined that the external device is set as the communication target; executing the internal application if the verified version is no earlier than a threshold; and issuing a warning if the verified version is older than the threshold.

It is to be noted that any optional combinations of the above constituent elements or an embodiment obtained by replacing what is expressed by the present disclosure among a method, an apparatus, a system, a recording medium, a computer program, and so on is also effective as an embodiment of the present disclosure.

### BRIEF DESCRIPTION OF THE DRAWINGS

FIG. 1 illustrates a structure of an interior of a compartment of a vehicle according to Embodiment 1;

FIG. 2 illustrates a configuration of an electronic device to be mounted in the vehicle illustrated in FIG. 1 and a configuration of an external device and a server;

FIGS. 3A and 3B each illustrate a warning to be displayed on a display unit illustrated in FIG. 2;

FIGS. 4A and 4B each illustrate another warning to be displayed on the display unit illustrated in FIG. 2;

FIGS. 5A and 5B each illustrate yet another warning to be displayed on the display unit illustrated in FIG. 2;

FIG. 6 is a sequence diagram illustrating a procedure of a process performed by the electronic device, the external device, and the server illustrated in FIG. 2;

FIG. 7 is a flowchart illustrating a procedure of a process performed by the electronic device illustrated in FIG. 2;

FIG. 8 is a flowchart illustrating a procedure performed by the electronic device illustrated in FIG. 2 in establishing a connection;

FIG. 9 illustrates a configuration of an electronic device to be mounted in a vehicle according to Embodiment 2 and a configuration of an external device;

FIG. 10 is a flowchart illustrating a procedure of a process performed by the electronic device illustrated in FIG. 9;

FIG. 11 illustrates a configuration of an electronic device to be mounted in the vehicle illustrated in FIG. 1 and a configuration of a first external device and a second external device;

FIGS. 12A and 12B each illustrate a warning to be displayed on a display unit illustrated in FIG. 11;

FIGS. 13A and 13B each illustrate another warning to be displayed on the display unit illustrated in FIG. 11;

FIG. 14 is a flowchart illustrating a procedure of a process performed by the electronic device illustrated in FIG. 11;

FIGS. 15A, 15B and 15C each illustrate a warning to be displayed on a display unit according to Embodiment 4;

FIGS. 16A, 16B and 16C each illustrate another warning to be displayed on the display unit according to Embodiment 4; and

FIG. 17 illustrates yet another warning to be displayed on the display unit according to Embodiment 4.

### DETAILED DESCRIPTION

The invention will now be described by reference to the preferred embodiments. This does not intend to limit the scope of the present invention, but to exemplify the invention.

### Embodiment 1

Prior to describing the present disclosure in concrete terms, an overview will be given. Embodiment 1 of the present disclosure relates to an electronic device to be mounted in a vehicle. An example of the electronic device is a navigation device. The electronic device has an internal application installed therein, and examples of the internal application include an application that can execute a navigation function and an application that can execute a function of playing a music or a video. The electronic device can communicate with an external device wirelessly or via a cable. An example of the external device is a smartphone. The external device has an external application installed therein that, when the external device is connected to the electronic device, operates in cooperation with the internal application. For example, when a destination is set in the external application, the internal application executes route guidance to the destination. When a music to be played is selected in the external application, the internal application plays the selected music.

Such external application and internal application are upgraded when a new function is added. If the external application has not been upgraded when the internal application has been upgraded, a new function may not be available, or the two applications may fail to connect to each other. This results in a failure to ensure the reliability of the applications. When a security hole is found in the external application and/or the internal application, a program patch for fixing the security hole is distributed as an upgrade. If the external application fails to be upgraded in such a situation, the security hole remains, and this results in a failure to ensure the reliability of the application. Ensuring the reliability requires an upgrade, and it is preferable that the devices be easy to operate when being upgraded. Accordingly, there is a demand that the reliability be ensured and the operation be easy at the same time.

In other words, when the internal application executed in the electronic device and the external application executed in the external device are to be connected, it is desired that the reliability be ensured and the devices be easy to operate at the same time. The present disclosure has been made in view of the above and is directed to providing a technology that, when two applications are to be connected, ensures the reliability and allows for an easy operation at the same time.

In order to ensure the reliability and allow for an easy operation at the same time, an electronic device according to the present embodiment presets an external device to which the electronic device can connect. Upon receiving an execution request for an internal application from an external device, the electronic device determines whether this external device is set as a communication target. If the external device is set as a communication target, the electronic device verifies, with the external device, the version of the external application executed in the external device. If the verified version is older than a threshold, the electronic device issues a warning. For example, a message such as “Unable to connect” is displayed on a monitor of the electronic device. This allows the user of the external device to execute an upgrade on the external application with ease.

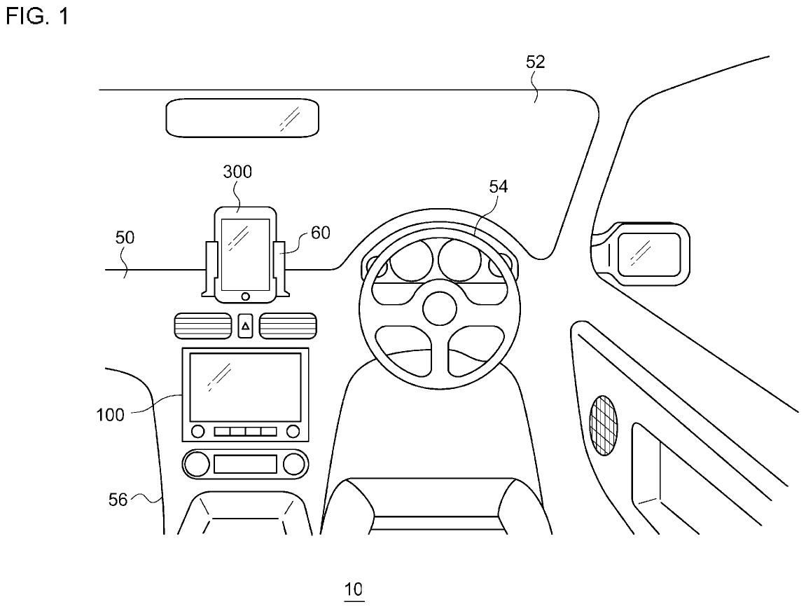

FIG. 1 illustrates a structure of an interior of a compartment of a vehicle 10. A dashboard 50 is disposed in the front part of the vehicle compartment, and a windshield 52 is disposed to the front of the dashboard 50. A steering wheel 54 is disposed in the right portion of the dashboard 50. Alternatively, the steering wheel 54 may be disposed in the left portion of the dashboard 50. A center console 56 extending in the up-down direction is disposed in the middle portion of the dashboard 50. An electronic device 100 is to be embedded in the center console 56. A holder 60 is installed on the center console 56. The holder 60 supports an external device 300. The external device 300 may be held by an occupant of the vehicle 10. The external device 300 and the electronic device 100 can be connected to each other wirelessly or via a cable.

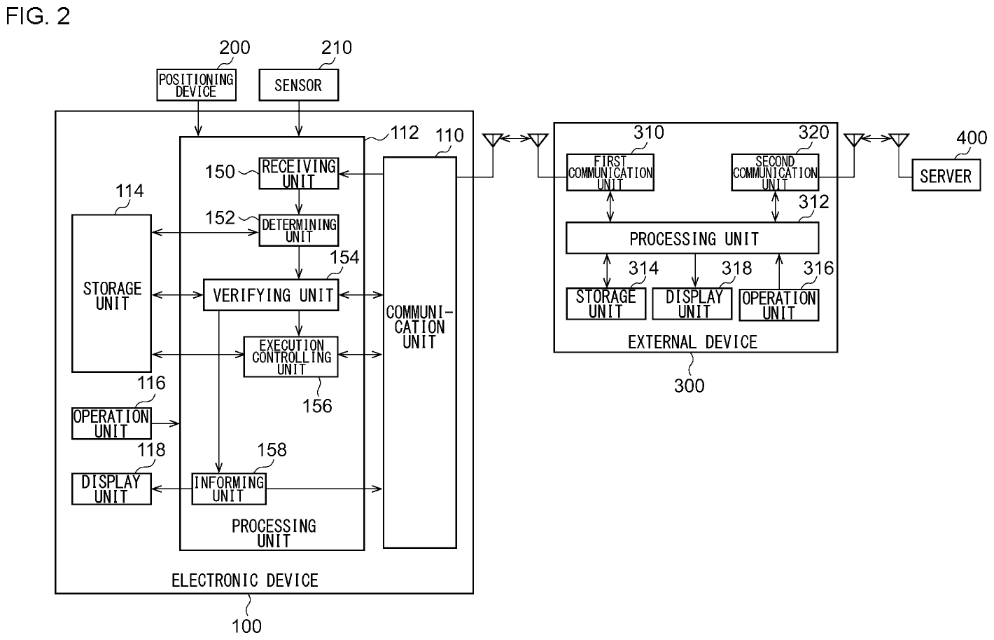

FIG. 2 illustrates a configuration of the electronic device 100 to be mounted in the vehicle 10 and a configuration of the external device 300 and a server 400. The electronic device 100 can have a positioning device 200 and a sensor 210 connected thereto. The electronic device 100 includes a communication unit 110, a processing unit 112, a storage unit 114, an operation unit 116, and a display unit 118. The processing unit 112 includes a receiving unit 150, a determining unit 152, a verifying unit 154, an execution controlling unit 156, and an informing unit 158. The external device 300 includes a first communication unit 310, a processing unit 312, a storage unit 314, an operation unit 316, a display unit 318, and a second communication unit 320.

As described above, the electronic device 100 is a navigation device or the like and is to be mounted in the vehicle 10. The positioning device 200 connected to the electronic device 100 measures the position of the vehicle 10 on the basis of a signal from a global navigation satellite system (GNSS) satellite and outputs measured position information to the electronic device 100. The sensor 210 connected to the electronic device 100 detects an environment surrounding the vehicle 10 and outputs a detected result (hereinafter, “detection result”) to the electronic device 100. For example, an infrared sensor, an ultrasonic sensor, or a proximity sensor is used for the sensor 210. The sensor 210 may be integrated with an imaging device and executes image recognition processing on a video captured by the imaging device. Any well-known technology may be used for the above, and descriptions thereof will be omitted.

The communication unit 110 executes wireless or wired communication. The communication unit 110 supports, for example,

Bluetooth (registered trademark) and/or a wireless local area network (LAN) as a wireless communication function. The storage unit 114 stores a program for an internal application (hereinafter, referred to as an “internal application”). The internal application is, for example, an application that can execute a navigation function or an application that can execute a function of playing a music or a video. These applications may be integrated together. The storage unit 114 also stores information other than the internal application, and this will be described later. The operation unit 116 is an interface to be operated by an occupant and is, for example, a button. The operation unit 116 may be integrated with the display unit 118, described later, in the form of a touch panel. The operation unit 116 receives an instruction from an occupant and outputs the received instruction to the processing unit 112. The display unit 118 is a monitor and displays a video, an image, and a message output from the processing unit 112.

In such a configuration, upon receiving an instruction from the operation unit 116, the execution controlling unit 156 of the processing unit 112 executes the internal application stored in the storage unit 114 and displays the result of the execution on the display unit 118. When the internal application can execute a navigation function, the execution controlling unit 156 executes the internal application to display a route guidance screen or the like on the display unit 118. When the route guidance is provided, the position information from the positioning device 200 and the detection result of the sensor 210 are used. When the internal application can execute a function of playing a video, the execution controlling unit 156 executes the internal application to display a played video on the display unit 118. When the internal application can execute a function of playing a music, the execution controlling unit 156 executes the internal application to output a played music through a loudspeaker (not illustrated). Any well-known technology may be used for the execution of these internal applications, and thus descriptions thereof will be omitted. When the execution controlling unit 156 is connected to the external device 300 via the communication unit 110, the execution controlling unit 156 can also execute the internal application in cooperation with an external application executed in the external device 300.

As described above, the external device 300 is a smartphone or the like. The first communication unit 310 supports a communication system common to the communication system of the communication unit 110 of the electronic device 100 and can communicate with the communication unit 110. The second communication unit 320 executes wireless communication. The second communication unit 320 supports, for example, long term evolution (LTE) and/or a metropolitan area network (MAN) as a wireless communication function. In this example, the communication system supported by the second communication unit 320 allows for a longer communication distance than the communication system supported by the first communication unit 310. The second communication unit 320 can communicate with the server 400.

The storage unit 314 stores a program for an external application (hereinafter, referred to as an “external application”). An external application refers to an application, among various applications, that operates in cooperation with an internal application. The external application is, for example, an application that cooperates with the internal application that can execute a navigation function or an application that cooperates with the internal application that can execute a function of playing a music or a video. These applications may be integrated together. The storage unit 314 may further store an application other than the external application, but descriptions of such an application will be omitted. The storage unit 314 may further store information other than an application.

The operation unit 316 is an interface to be operated by an occupant and is, for example, a button. The operation unit 316 may be integrated with the display unit 318, described later, in the form of a touch panel. The operation unit 316 receives an instruction from an occupant and outputs the received instruction to the processing unit 312. The display unit 318 is a monitor and displays a video, an image, and a message output from the processing unit 312.

The server 400 provides the internal application to be executed in the electronic device 100, the external application to be executed in the external device 300, and an application other than the external application to be executed in the external device 300. The server 400 also provides data related to at least one of the aforementioned applications. In this example, the server 400 manages data for upgrading the external application. The server 400 also manages the version of the external application.

Now, a process performed when an occupant starts the internal application in the electronic device 100 by operating the external application in the external device 300 in the above-described configuration will be described. The occupant inputs an instruction for starting the external application by using the operation unit 316 of the external device 300. The processing unit 312 starts the external application stored in the storage unit 314 in accordance with the received instruction.

As described above, the external application is an application that operates in cooperation with the internal application. Therefore, the external application being executed in the processing unit 312 generates a signal requesting the internal application to be started (hereinafter, referred to as an “execution request”) and outputs the execution request to the first communication unit 310. The execution request includes identification information for identifying the external device 300. The first communication unit 310 transmits the execution request to the electronic device 100.

The communication unit 110 of the electronic device 100 receives the execution request from the external device 300. The communication unit 110 outputs the received execution request to the processing unit 112. The receiving unit 150 of the processing unit 112 receives the execution request for the internal application from the communication unit 110. The receiving unit 150 outputs the received execution request to the determining unit 152. The determining unit 152 receives the execution request from the receiving unit 150. The determining unit 152 extracts the identification information from the execution request. The determining unit 152 determines whether the extracted identification information is stored in the storage unit 114. In this example, one or more pieces of identification information are stored in advance in the storage unit 114. The one or more pieces of identification information identify external devices 300 set as communication targets of the internal application for which the receiving unit 150 has received the execution request. Therefore, it can be said that the determining unit 152 determines whether the external device 300 that has transmitted the execution request is set as a communication target. If the determining unit 152 has determined that the external device 300 is not set as a communication target, the determining unit 152 terminates the process. Meanwhile, if the determining unit 152 has determined that the external device 300 is set as a communication target, the determining unit 152 outputs the execution request to the verifying unit 154.

If the verifying unit 154 has received the execution request from the determining unit 152, the verifying unit 154 outputs, to the communication unit 110, a signal requesting the external device 300 to transmit information indicating the version of the external application executed in the external device 300 (hereinafter, referred to as a “version request”). The information indicating the version of the external application is also referred to as “version information.” Upon receiving the version request from the verifying unit 154, the communication unit 110 transmits the version request to the external device 300.

The first communication unit 310 of the external device 300 receives the version request from the electronic device 100. The first communication unit 310 outputs the received version request to the processing unit 312. Upon receiving the version request, the external application being executed in the processing unit 312 outputs the version information of the external application to the first communication unit 310. The first communication unit 310 transmits the received version information to the electronic device 100.

The communication unit 110 of the electronic device 100 receives the version information from the external device 300. The communication unit 110 outputs the received version information to the verifying unit 154. The storage unit 114 stores a threshold for the version. This threshold is preset as a version of the external application that operates without any problem when cooperating with the internal application. For example, the processing unit 112 connects to the server 400 via the communication unit 110 and the external device 300, acquires the threshold from the server 400, and stores the acquired threshold into the storage unit 114. Alternatively, the processing unit 112 may include a communication unit, separate from the communication unit 110, that can connect to the server 400, and the processing unit 112 may connect to the server 400 via this communication unit, acquire the threshold from the server 400, and store the acquired threshold into the storage unit 114.

Upon receiving the version information from the communication unit 110, the verifying unit 154 acquires the threshold stored in the storage unit 114. The verifying unit 154 compares the version indicated by the version information against the threshold. If the version is no earlier than the threshold, the verifying unit 154 determines to execute the internal application and instructs the execution controlling unit 156 to execute the internal application. Meanwhile, if the version is older than the threshold, the verifying unit 154 instructs the informing unit 158 to issue a warning.

When the execution controlling unit 156 is instructed to execute the internal application by the verifying unit 154, the execution controlling unit 156 executes the internal application. The internal application is executed as described above. In this example, the internal application cooperates with the external application in the external device 300 via the communication unit 110. For example, an instruction for the external application input via the operation unit 316 is input to the execution controlling unit 156 via the first communication unit 310 and the communication unit 110, and the internal application executes a process corresponding to the input instruction. In addition, a result from the process executed by the internal application is input to the processing unit 312 via the communication unit 110 and the first communication unit 310, and the external application displays this result on the display unit 318.

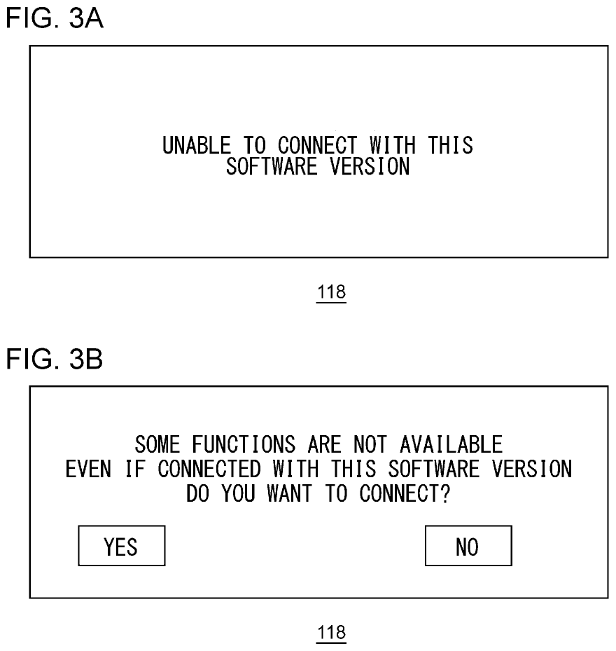

When the informing unit 158 is instructed to issue a warning by the verifying unit 154, the informing unit 158 displays a warning on the display unit 118. The informing unit 158 may output a sound corresponding to a warning through a loudspeaker (not illustrated). FIGS. 3A and 3B each illustrate a warning to be displayed on the display unit 118. In FIG. 3A, the message

“Unable to connect with this software version” is displayed. This corresponds to displaying a warning indicating that a connection cannot be established. In FIG. 3B, the messages “Some functions are unavailable even if connected with this software version” and “Do you want to connect?” along with the buttons indicating “Yes” and “No” are displayed. This corresponds to displaying a warning indicating that one or more functions of the internal application are unavailable. Referring back to FIG. 2, the occupant selects the “Yes” button by operating the operation unit 116 when the occupant is to connect the electronic device 100 or selects the “No” button by operating the operation unit 116 when the occupant is not to connect the electronic device 100. The verifying unit 154 receives the selection result from the operation unit 116. When the selection result is “Yes,” the verifying unit 154 instructs the execution controlling unit 156 to execute the internal application. Meanwhile, when the selection result is “No,” the verifying unit 154 terminates the process.

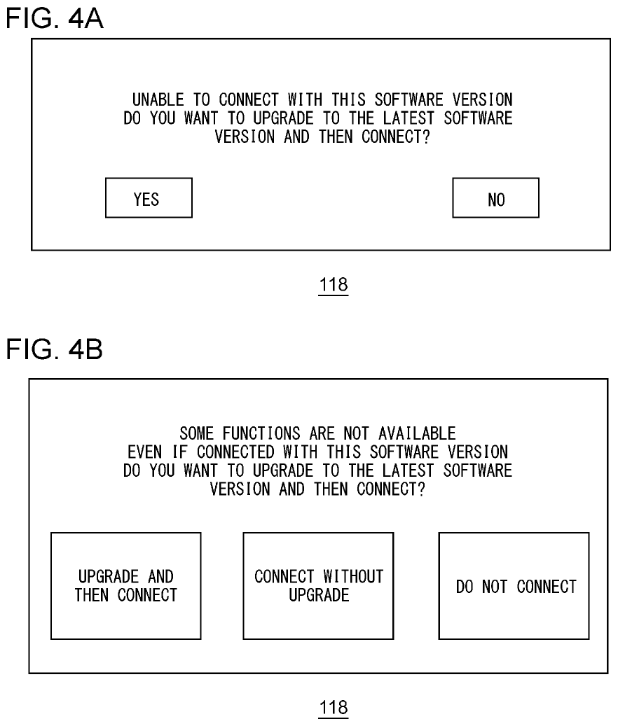

FIGS. 4A and 4B each illustrate another warning to be displayed on the display unit 118. In FIG. 4A, in addition to the message “Unable to connect with this software version” as in FIG. 3A, the message “Do you want to upgrade to the latest software version and then connect?” is also displayed. In addition, the buttons indicating “Yes” and “No” are displayed. This corresponds to displaying a warning prompting for an upgrade of the external application. Referring back to FIG. 2, the occupant selects the “No” button by operating the operation unit 116 when the occupant is not to upgrade the external application or selects the “Yes” button by operating the operation unit 116 when the occupant is to upgrade the external application. The verifying unit 154 receives the selection result from the operation unit 116. When the selection result is “No,” the verifying unit 154 terminates the process. When the selection result is “Yes,” the verifying unit 154 outputs, to the communication unit 110, a signal instructing the external device 300 to upgrade the external application (hereinafter, referred to as an “upgrade instruction”). The communication unit 110 transmits the upgrade instruction to the external device 300.

The first communication unit 310 of the external device 300 receives the upgrade instruction from the electronic device 100. The first communication unit 310 outputs the received upgrade instruction to the processing unit 312. Upon receiving the upgrade instruction, the external application being executed in the processing unit 312 outputs, to the second communication unit 320, a signal requesting for an upgrade (hereinafter, referred to as an “upgrade request”). The second communication unit 320 transmits the upgrade request to the server 400. Upon receiving the upgrade request from the external device 300, the server 400 transmits a program update for a new version to the external device 300.

The second communication unit 320 of the external device 300 receives the program update from the server 400.

The second communication unit 320 outputs the program update to the processing unit 312. The processing unit 312 updates the external application with the program update. This process corresponds to upgrading of the external application. The upgraded external application outputs the version information of the external application to the first communication unit 310. The first communication unit 310 transmits the received version information to the electronic device 100.

Upon receiving the version information from the communication unit 110, the verifying unit 154 retrieves the threshold stored in the storage unit 114. The verifying unit 154 compares the version indicated by the version information against the threshold. Since this version is no earlier than the threshold, the verifying unit 154 determines to execute the internal application and instructs the execution controlling unit 156 to execute the internal application.

In FIG. 4B, in addition to the message “Some functions are unavailable even if connected with this software version” as in FIG. 3B, the message “Do you want to upgrade to the latest software version and then connect?” as in FIG. 4A is also displayed. In addition, the buttons indicating “Upgrade and then connect,” “Connect without upgrade,” and “Do not connect” are displayed. This also corresponds to displaying a warning prompting for an upgrade of the external application.

Referring back to FIG. 2, the occupant selects the “Upgrade and then connect” button by operating the operation unit 116 when the occupant is to upgrade the external application or selects the “Connect without upgrade” button by operating the operation unit 116 when the occupant is to connect the electronic device 100 without upgrading the external application. Furthermore, the occupant selects the “Do not connect” button by operating the operation unit 116 when the occupant is not to connect the electronic device 100. The verifying unit 154 receives the selection result from the operation unit 116. When the selection result is “Upgrade and then connect,” the verifying unit 154 executes a process similar to the process executed when the selection result is “Yes” in FIG. 4A. When the selection result is “Connect without upgrade,” the verifying unit 154 executes a process similar to the process executed when the selection result is “Yes” in FIG. 3B. When the selection result is “Do not connect,” the verifying unit 154 executes a process similar to the process executed when the selection result is “No” in FIG. 3B.

Now, another process of the verifying unit 154 will be described. The verifying unit 154 compares the version indicated by the version information against the threshold. If the version is no earlier than the threshold, as in the above case, the verifying unit 154 determines to execute the internal application and instructs the execution controlling unit 156 to execute the internal application. Meanwhile, if the version is older than the threshold, the verifying unit 154 determines whether the version is within a predetermined interval from the threshold (hereinafter, referred to as a “first state”) or the version is older than the threshold by more than the predetermined interval (hereinafter, referred to as a “second state”). The second state means that the version is older than the version in the first state.

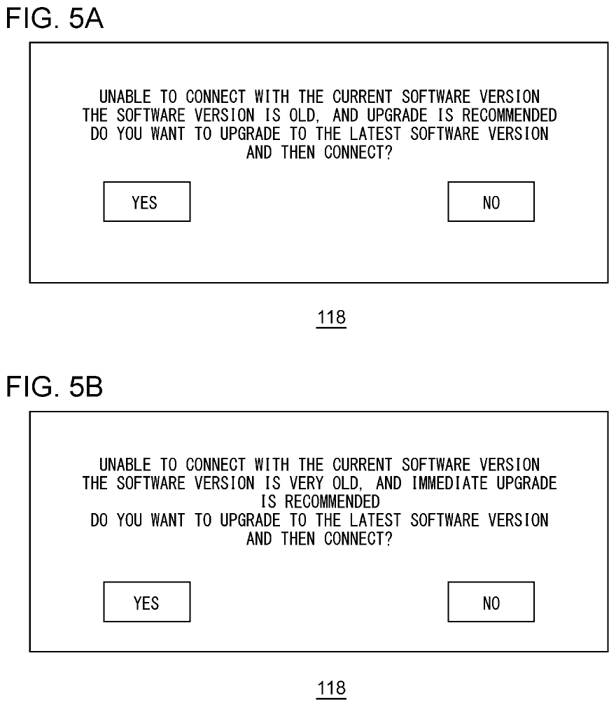

FIGS. 5A and 5B each illustrate yet another warning to be displayed on the display unit 118. FIG. 5A illustrates a screen displayed when the verifying unit 154 has determined that the version is in the first state. The message “Unable to connect with the current software version. The software version is old, and upgrade is recommended. Do you want to upgrade to the latest software version and then connect?” is displayed. In addition, the buttons indicating “Yes” and “No” are displayed. Referring back to FIG. 2, the occupant selects the “Yes” button by operating the operation unit 116 when the occupant is to upgrade the external application or selects the “No” button by operating the operation unit 116 when the occupant is not to connect the electronic device 100. The verifying unit 154 receives the selection result from the operation unit 116. When the selection result is “Yes, ” the verifying unit 154 executes a process similar to the process executed when the selection result is “Yes” in FIG. 4A. When the selection result is “No,” the verifying unit 154 executes a process similar to the process executed when the selection result is “No” in FIG. 4A.

FIG. 5B illustrates a screen displayed when the verifying unit 154 has determined that the version is in the second state. The message “Unable to connect with the current software version. The software version is very old, and immediate upgrade is recommended. Do you want to upgrade to the latest software version and then connect?” is displayed. In addition, the buttons indicating “Yes” and “No” are displayed. Referring back to FIG. 2, the occupant selects the “Yes” button by operating the operation unit 116 when the occupant is to upgrade the external application or selects the “No” button by operating the operation unit 116 when the occupant is not to connect the electronic device 100. The verifying unit 154 receives the selection result from the operation unit 116. When the selection result is “Yes,” the verifying unit 154 executes a process similar to the process executed when the selection result is “Yes” in FIG. 4A. When the selection result is “No,” the verifying unit 154 executes a process similar to the process executed when the selection result is “No” in FIG. 4A. In this manner, the informing unit 158 changes the content of the warning in accordance with the difference between the version verified in the verifying unit 154 and the threshold.

In the foregoing, wireless or wired communication is executed between the communication unit 110 and the first communication unit 310. In the following, two types of communication may be executed between the communication unit 110 and the first communication unit 310. One of the two types of communication is referred to as a first communication circuit, and the other type of communication is referred to as a second communication circuit. For example, the first communication circuit is a wireless communication circuit, and the second communication circuit is a wired communication circuit. In such a configuration, if the communication quality of the first communication circuit deteriorates while the internal application and the external application are operating in cooperation with each other through the first communication circuit, the communication unit 110 and the first communication unit 310 switch the communication circuit from the first communication circuit to the second communication circuit. For example, when one of the communication unit 110 and the first communication unit 310 has detected a deterioration in the communication quality, the one that has detected the deterioration requests the other to switch the communication circuit. When the other of the communication unit 110 and the first communication unit 310 has approved the switch in the communication circuit, the communication unit 110 and the first communication unit 310 switch the communication circuit. As a result, the internal application and the external application operate in cooperation with each other through the second communication circuit. Meanwhile, when the second communication circuit is not present, the communication unit 110 disconnects the first communication circuit, and the informing unit 158 causes the operation unit 116 to display a warning. This warning indicates that the first communication circuit has been disconnected.

The above configuration can be implemented in hardware, such as a central processing unit (CPU) of a desired computer, a memory, or a large-scale integration (LSI), or in software, such as a program loaded on a memory. In this example, the configuration is depicted in the form of functional blocks implemented through cooperation of hardware and software. It is to be understood by a person skilled in the art that these functional blocks can be implemented in various forms solely through hardware or through a combination of hardware and software.

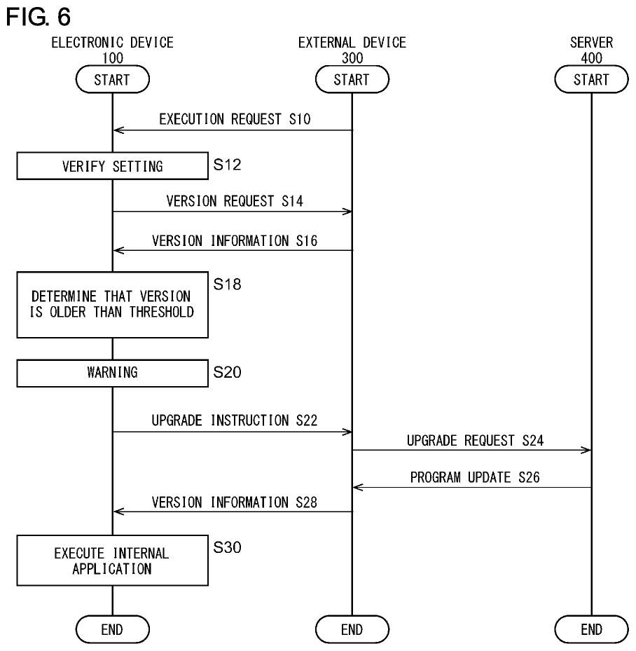

An operation of the electronic device 100, the external device 300, and the server 400 configured as described above will be described. FIG. 6 is a sequence diagram illustrating a procedure of a process performed by the electronic device 100, the external device 300, and the server 400. The external device 300 transmits an execution request to the electronic device 100 (S10). The electronic device 100 verifies the setting (S12). Since the external device 300 is set as a communication target, the electronic device 100 transmits a version request to the external device 300 (S14). The external device 300 transmits version information to the electronic device 100 (S16). The electronic device 100 determines that the version is older than the threshold (S18). The electronic device 100 issues a warning (S20). The electronic device 100 transmits an upgrade instruction to the external device 300 (S22). The external device 300 transmits an upgrade request to the server 400 (S24). The server 400 transmits a program update to the external device 300 (S26). Upon executing the upgrade, the external device 300 transmits version information to the electronic device 100 (S28). The electronic device 100 executes the internal application (S30).

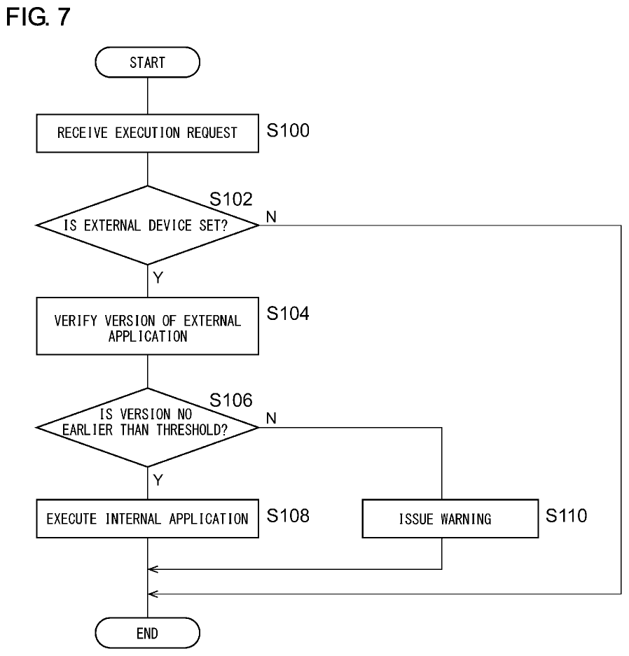

FIG. 7 is a flowchart illustrating a procedure of a process performed by the electronic device 100. The receiving unit 150 receives an execution request (S100). If the determining unit 152 has determined that the external device 300 is set as a communication target (Y in S102), the verifying unit 154 verifies the version of the external application (S104). If the version is no earlier than the threshold (Y in S106), the execution controlling unit 156 executes the internal application (S108). If the version is older than the threshold (N in S106), the informing unit 158 issues a warning (S110). If the determining unit 152 has determined that the external device 300 is not set as a communication target (N in S102), the process is terminated.

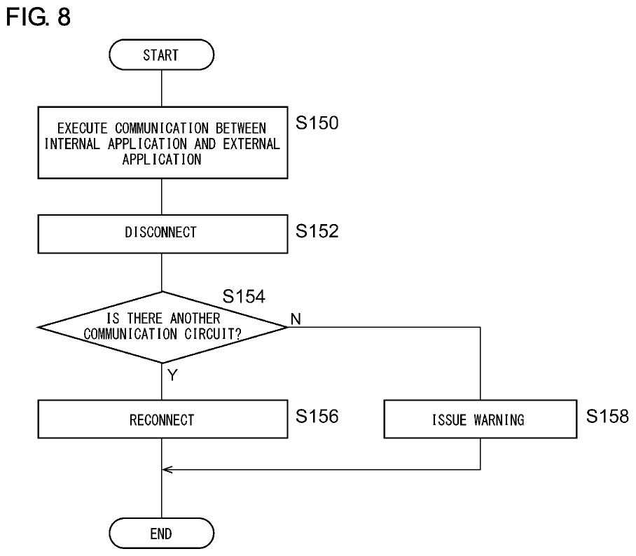

FIG. 8 is a flowchart illustrating a procedure performed by the electronic device 100 in establishing a connection. The communication unit 110 executes communication between the internal application and the external application (S150). The communication unit 110 disconnects a communication circuit (S152). If there is another communication circuit (Y in S154), the communication unit 110 executes a reconnection through the other communication circuit (S156). If there is no other communication circuit (N in S154), the informing unit 158 issues a warning (S158).

According to the embodiment of the present disclosure, if the external device is set as a communication target, and if the version of the external application is older than the threshold, a warning is issued. This allows an occupant to be informed that the occupant is using an old version of the application. Informing the occupant that he/she is using an old version of the application allows the reliability to be ensured. Informing the occupant automatically that he/she is using an old version of the application allows for an easy operation. If the external device is set as a communication target, and if the version of the external application is older than the threshold, a warning is issued. This makes it possible to ensure the reliability and to allow for an easy operation at the same time when connecting the two applications.

Issuing a warning indicating that the connection cannot be established allows the occupant to be informed that the connection cannot be established. Issuing a warning indicating that some functions of the internal application are unavailable allows the occupant to be informed that some functions of the internal application are unavailable. Issuing a warning prompting for an upgrade of the external application allows the occupant to upgrade the external application more easily. Changing the content of the warning in accordance with a difference between the version and the threshold allows the occupant to be informed how old the version is. Informing the occupant how old the version is helps prompt for an upgrade. If the communication quality through a first communication circuit has deteriorated, the communication circuit is switched from the first communication circuit to a second communication circuit. This allows the cooperation of the two applications to continue even when the communication quality has deteriorated.

### Embodiment 2

Next, Embodiment 2 will be described. As with Embodiment 1, Embodiment 2 relates to an electronic device to be mounted in a vehicle. In addition, an internal application in the electronic device and an external application in an external device operate in cooperation with each other. In order to ensure the reliability of such applications, the electronic device, upon receiving an execution request for the internal application from the external device, determines whether the external device is set as a communication target. The electronic device executes the internal application if the external device is set as a communication target or refrains from executing the internal application if the external device is not set as a communication target. In order to achieve such a process, the external device needs to be preset as a communication target in the electronic device. Furthermore, when a plurality of external devices are available as communication targets of the electronic device, each of the external device needs to be preset in the electronic device. In consideration of allowing for an easy operation for an occupant, it is desirable that such settings be performed with ease.

In order to ensure the reliability and allow for an easy operation at the same time, an electronic device according to the present embodiment does not set one external device (hereinafter, referred to as a “first external device”) as a communication target but presets another external device (hereinafter, referred to as a “second external device”) as a communication target. This example assumes a situation in which a first occupant carrying the first external device and a second occupant carrying the second external device are in a vehicle. The first occupant operates the first external device to start an external application. To operate in cooperation with an internal application in the electronic device, an external application transmits an execution request for the internal application to the electronic device. Upon receiving the execution request for the internal application from a first external device, the electronic device determines whether the first external device is set as a communication target. Since the first external device is not set as a communication target, the electronic device verifies with the connected second external device whether the electronic device may communicate with the first external device. If the result from the verification indicates that the electronic device may communicate with the first external device, the electronic device starts the internal application. Thus, the internal application in the electronic device and the external application in the first external device operate in cooperation with each other. The description below centers on the differences from the foregoing.

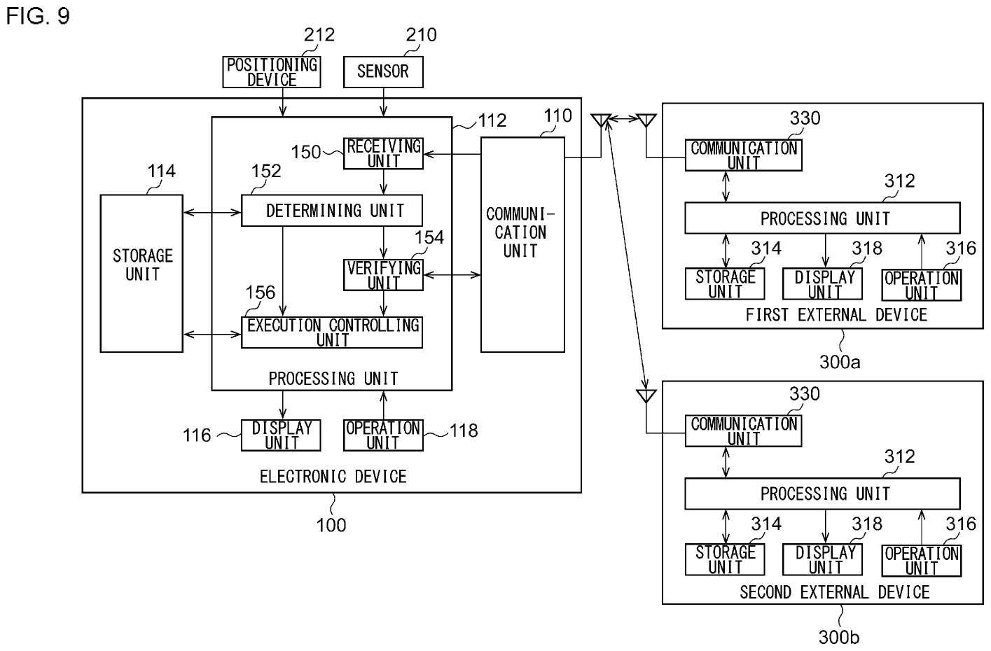

FIG. 9 illustrates a configuration of an electronic device 100 to be mounted in a vehicle 10 and a configuration of an external device 300. The electronic device 100 can c0ommunicate with a first external device 300a and a second external device 300b, which are collectively referred to as the external device 300. The number of external devices 300 that can communicate with the electronic device 100 may be three or more. The electronic device 100 can have a positioning device 200 and a sensor 210 connected thereto. The electronic device 100 includes a communication unit 110, a processing unit 112, a storage unit 114, an operation unit 116, and a display unit 118. The processing unit 112 includes a receiving unit 150, a determining unit 152, a verifying unit 154, and an execution controlling unit 156. The external device 300 includes a processing unit 312, a storage unit 314, an operation unit 316, a display unit 318, and a communication unit 330.

As described above, the storage unit 114 of the electronic device 100 stores one or more pieces of identification information in advance. The one or more pieces of identification information identify external devices 300 set as communication targets of the internal application for which the receiving unit 150 receives an execution request. In this example, whereas the identification information of the first external device 300a is not stored in the storage unit 114, the identification information of the second external device 300b is stored in the storage unit 114.

Now, a process performed when a first occupant starts the internal application in the electronic device 100 while operating the external application in the first external device 300a in the above-described configuration will be described. The first occupant inputs an instruction for starting the external application by using the operation unit 316 of the first external device 300a. The processing unit 312 starts the external application stored in the storage unit 314 in accordance with the received instruction. The external application being executed in the processing unit 312 outputs an execution request to the communication unit 330. The execution request includes identification information for identifying the first external device 300a. The communication unit 330 transmits the execution request to the electronic device 100.

The communication unit 110 of the electronic device 100 receives the execution request from the first external device 300a. The communication unit 110 outputs the received execution request to the processing unit 112. The receiving unit 150 of the processing unit 112 receives the execution request for the internal application from the communication unit 110. The receiving unit 150 outputs the received execution request to the determining unit 152. The determining unit 152 receives the execution request from the receiving unit 150. The determining unit 152 extracts the identification information from the execution request. This identification information is the identification information of the first external device 300a. The determining unit 152 determines whether the extracted identification information is stored in the storage unit 114. Thus, it can be said that the determining unit 152 determines whether the first external device 300a that has transmitted the execution request is set as a communication target. If the determining unit 152 has determined that the first external device 300a is set as a communication target, the determining unit 152 determines to execute the internal application and instructs the execution controlling unit 156 to execute the internal application. If the determining unit 152 has determined that the first external device 300a is not set as a communication target, the determining unit 152 instructs the verifying unit 154 to verify the first external device 300a.

The verifying unit 154 receives the instruction for verifying the first external device 300a from the determining unit 152. The verifying unit 154 refers to the storage unit 114 to determine that the second external device 300b is set as a communication target. The verifying unit 154 outputs, to the communication unit 110, a signal verifying with the second external device 300b whether the electronic device 100 may communicate with the first external device 300a (hereinafter, referred to as a “verification request”). The verification request includes the identification information of the first external device 300a. The communication unit 110 transmits the verification request to the second external device 300b.

The communication unit 330 of the second external device 300b receives the verification request from the electronic device 100. The communication unit 330 outputs the verification request to the processing unit 312. The processing unit 312 extracts the identification information of the first external device 300a from the received verification request. The processing unit 312 determines whether the electronic device 100 may communicate with the first external device 300a on the basis of the identification information. For example, identification information of external devices 300 that can communicate with the internal application is set in the external application stored in the storage unit 314, and the processing unit 312 determines whether the identification information of the first external device 300a is included in the identification information set in the external application. If the identification information of the first external device 300a is included, the processing unit 312 determines that the electronic device 100 may communicate with the first external device 300a.

If the identification information of the first external device 300a is not included, the processing unit 312 determines that the electronic device 100 is not allowed to communicate with the first external device 300a.

Alternatively, if the identification information of the first external device 300a is registered in a phone directory application, the processing unit 312 may determine that the electronic device 100 may communicate with the first external device 300a. Meanwhile, if the identification information of the first external device 300a is not registered in the phone directory application, the processing unit 312 may determine that the electronic device 100 is not allowed to communicate with the first external device 300a. The phone directory application corresponds to an application other than the external application.

Furthermore, the processing unit 312 may display a message, on the display unit 318, for checking with a second occupant whether the electronic device 100 may communicate with the first external device 300a. Upon acknowledging the message, the second occupant operates the operation unit 316 to input whether the electronic device 100 may communicate with the first external device 300a. The processing unit 312 receives, from the operation unit 316, an input indicating whether the electronic device 100 may communicate with the first external device 300a. The processing unit 312 outputs, to the communication unit 330, a signal indicating whether the electronic device 100 may communicate with the first external device 300a (hereinafter, referred to as a “verification response”). The communication unit 330 transmits the verification response to the electronic device 100. In other words, the second external device 300b requested for a verification by the verifying unit 154 responds whether the electronic device 100 may communicate with the first external device 300a on the basis of the setting in the external application. In addition, the second external device 300b requested for a verification by the verifying unit 154 may respond whether the electronic device 100 may communicate with the first external device 300a on the basis of the setting in an application other than the external application.

The communication unit 110 of the electronic device 100 receives the verification response from the second external device 300b. The communication unit 110 outputs the received verification response to the verifying unit 154. The verifying unit 154 receives the verification response. The verifying unit 154 determines whether the electronic device 100 may communicate with the first external device 300a on the basis of the received verification response. If the verification response indicates that the electronic device 100 is not allowed to communicate with the first external device 300a, the verifying unit 154 terminates the process. Meanwhile, if the verification response indicates that the electronic device 100 may communicate with the first external device 300a, the verifying unit 154 determines to execute the internal application and instructs the execution controlling unit 156 to execute the internal application.

When the execution controlling unit 156 is instructed to execute the internal application by the verifying unit 154, the execution controlling unit 156 executes the internal application. The internal application operates in cooperation with the external application in the first external device 300a. In the present embodiment as well, two types of communication may be executed between the communication unit 110 and the communication unit 330. In such a configuration, if the communication quality of a first communication circuit deteriorates while the internal application and the external application are operating in cooperation with each other through the first communication circuit, the communication unit 110 and the communication unit 330 switch the communication circuit from the first communication circuit to a second communication circuit.

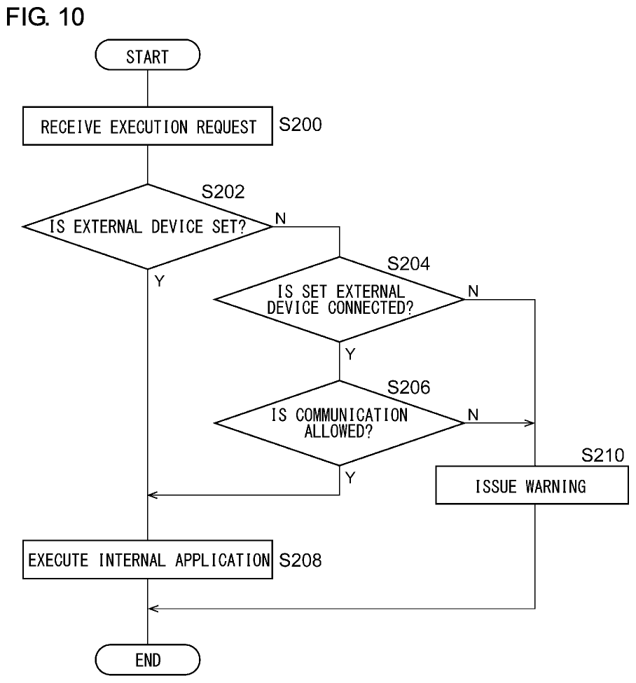

FIG. 10 is a flowchart illustrating a procedure of a process performed by the electronic device 100. The receiving unit 150 receives an execution request (S200). If the determining unit 152 has determined that the external device 300 that has transmitted the execution request is set as a communication target (Y in S202), the execution controlling unit 156 executes the internal application (S208). If the determining unit 152 has determined that the external device 300 that has transmitted the execution request is not set as a communication target (N in S202), and if another external device 300 set as a communication target is connected to the communication unit 110 (Y in S204), the verifying unit 154 verifies with this external device 300 whether the electronic device 100 is allowed to communicate with the external device 300 that has transmitted the execution request (S206). If the communication is allowed (Y in S206), the execution controlling unit 156 executes the internal application (S208). If no external device 300 set as a communication target is connected to the communication unit 110 (N in S204), or if the communication is not allowed (N in S206), the process is terminated.

According to the present embodiment, when it has been determined that the first external device is not set as a communication target, the electronic device verifies with the second external device set as a communication target whether the electronic device may communicate with the first external device. This makes it possible to ensure the reliability in connecting the first external device. When it has been determined that the first external device is not set as a communication target, the electronic device verifies with the second external device set as a communication target whether the electronic device may communicate with the first external device. This renders it unnecessary to configure the first external device. Since the first external device does not need to be configured, this can simplify the operation. When it has been determined that the first external device is not set as a communication target, the electronic device verifies with the second external device set as a communication target whether the electronic device may communicate with the first external device. This makes it possible to ensure the reliability and to allow for an easy operation at the same time.

The second external device responds whether the electronic device may communicate with the first external device on the basis of the setting in the external application. This makes it possible to ensure the reliability and to allow for an easy operation at the same time. The second external device responds whether the electronic device may communicate with the first external device on the basis of the setting in an application other than the external application. This makes it possible to ensure the reliability and to allow for an easy operation at the same time. When the communication quality through the first communication circuit has deteriorated, the communication circuit is switched from the first communication circuit to the second communication circuit. This allows the cooperation of the two applications to continue even when the communication quality has deteriorated.

### Embodiment 3

Prior to describing the present disclosure in concrete terms, an overview will be given. Embodiment 3 of the present disclosure relates to an electronic device to be mounted in a vehicle. An example of the electronic device is a navigation device. The electronic device has an internal application installed therein, and examples of the internal application include an application that can execute a navigation function and an application that can execute a function of playing a music or a video. The electronic device can communicate with an external device wirelessly or via a cable. An example of the external device is a smartphone. The external device has an external application installed therein that, when the external device is connected to the electronic device, operates in cooperation with the internal application. For example, when a destination is set in the external application, the internal application executes route guidance to the destination. When a music to be played is selected in the external application, the internal application plays the selected music.

When two occupants are in a vehicle and carry their respective external devices, external applications executed in the external devices can each connect to an internal application executed in the electronic device. When such connections are established, the processing load in the electronic device increases, and in turn the processing speed of the external applications executed in the external devices may decrease. In this case, if one of the occupants is not aware of the connection of the external application executed in the external device used by the other occupant, the occupant feels that the processing speed is low for an unknown cause. This results in reduced user-friendliness for the occupant. Accordingly, it is preferable that the occupants can recognize the connection between the internal application and each of the external applications executed in the respective external devices.

In other words, an improvement in the user-friendliness is expected through a connection between an application executed in an electronic device (hereinafter, referred to as an “internal application”) and an application executed in an external device (hereinafter, referred to as an “external application”). There may be a case in which external applications executed in a plurality of external devices are each connected to an internal application. When the user is not aware of such connections, the processing speed may decrease for a cause unknown to the user. Accordingly, it is preferable that the users can recognize the connection between the internal application and each of the external applications executed in the respective external devices. The present disclosure has been made in view of the above and is directed to providing a technology that allows a user to recognize a connection between an internal application and each of external applications executed in respective external devices.

The present embodiment assumes a situation in which an internal application executed in an electronic device is connected to an external application executed in one external device (hereinafter, referred to as a “first external device”). In such a situation, when another external device (hereinafter, referred to as a “second external device”) has requested the electronic device to execute the internal application, the electronic device outputs an alert. This alert allows the user to recognize that the external applications executed in the respective external devices are to be connected to the internal application.

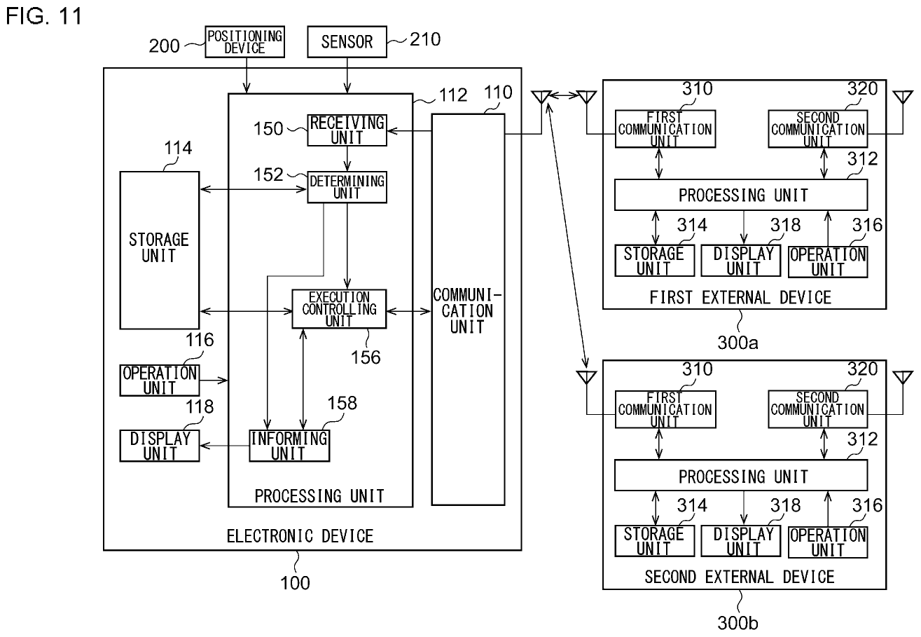

FIG. 11 illustrates a configuration of an electronic device 100 to be mounted in a vehicle 10 and a configuration of a first external device 300a and a second external device 300b. The electronic device 100 can have a positioning device 200 and a sensor 210 connected thereto. The electronic device 100 includes a communication unit 110, a processing unit 112, a storage unit 114, an operation unit 116, and a display unit 118. The processing unit 112 includes a receiving unit 150, a determining unit 152, an execution controlling unit 156, and an informing unit 158. The first external device 300a and the second external device 300b are collectively referred to as the external device 300. The external device 300 includes a first communication unit 310, a processing unit 312, a storage unit 314, an operation unit 316, a display unit 318, and a second communication unit 320.

As described above, the electronic device 100 is a navigation device or the like and is to be mounted in the vehicle 10. The positioning device 200 connected to the electronic device 100 measures the position of the vehicle 10 on the basis of a signal from a GNSS satellite and outputs measured position information to the electronic device 100. The sensor 210 connected to the electronic device 100 detects an environment surrounding the vehicle 10 and outputs a detected result (hereinafter, “detection result”) to the electronic device 100. For example, an infrared sensor, an ultrasonic sensor, or a proximity sensor is used for the sensor 210. The sensor 210 may be integrated with an imaging device and executes image recognition processing on a video captured by the imaging device. Any well-known technology may be used for the above, and descriptions thereof will be omitted.

The communication unit 110 executes wireless or wired communication. The communication unit 110 supports, for example, Bluetooth (registered trademark) and/or a wireless LAN as a wireless communication function. The storage unit 114 stores a program for an internal application (hereinafter, referred to as an “internal application”). The internal application is, for example, an application that can execute a navigation function or an application that can execute a function of playing a music or a video. These applications may be integrated together. The storage unit 114 also stores information other than the internal application, and this will be described later. The operation unit 116 is an interface to be operated by an occupant and is, for example, a button. The operation unit 116 may be integrated with the display unit 118, described later, in the form of a touch panel. The operation unit 116 receives an instruction from an occupant and outputs the received instruction to the processing unit 112 . The display unit 118 is a monitor and displays a video, an image, and a message output from the processing unit 112.

In such a configuration, upon receiving an instruction from the operation unit 116, the execution controlling unit 156 of the processing unit 112 executes the internal application stored in the storage unit 114 and displays the result of the execution on the display unit 118. When the internal application can execute a navigation function, the execution controlling unit 156 executes the internal application to display a route guidance screen or the like on the display unit 118. When the route guidance is provided, the position information from the positioning device 200 and the detection result of the sensor 210 are used. When the internal application can execute a function of playing a video, the execution controlling unit 156 executes the internal application to display a played video on the display unit 118. When the internal application can execute a function of playing a music, the execution controlling unit 156 executes the internal application to output a played music through a loudspeaker (not illustrated). Any well-known technology may be used for the execution of these internal applications, and thus descriptions thereof will be omitted. When the execution controlling unit 156 is connected to the external device 300 via the communication unit 110, the execution controlling unit 156 can also execute the internal application in cooperation with an external application executed in the external device 300.

As described above, the external device 300 is a smartphone or the like. The first communication unit 310 supports a communication system common to the communication system of the communication unit 110 of the electronic device 100 and can communicate with the communication unit 110. The second communication unit 320 executes wireless communication. The second communication unit 320 supports, for example, LTE and/or a MAN as a wireless communication function. In this example, the communication system supported by the second communication unit 320 allows for a longer communication distance than the communication system supported by the first communication unit 310.

The storage unit 314 stores a program for an external application (hereinafter, referred to as an “external application”). An external application refers to an application, among various applications, that operates in cooperation with an internal application. The external application is, for example, an application that cooperates with the internal application that can execute a navigation function or an application that cooperates with the internal application that can execute a function of playing a music or a video. These applications may be integrated together. The storage unit 314 may further store an application other than the external application, but descriptions of such an application will be omitted. The storage unit 314 may further store information other than an application.

The operation unit 316 is an interface to be operated by an occupant and is, for example, a button. The operation unit 316 may be integrated with the display unit 318, described later, in the form of a touch panel. The operation unit 316 receives an instruction from an occupant and outputs the received instruction to the processing unit 312. The display unit 318 is a monitor and displays a video, an image, and a message output from the processing unit 312.

Now, (1) a process performed when a first occupant starts the internal application in the electronic device 100 while operating the external application in the first external device 300a in the above-described configuration will be described. Then, (2) a process performed when a second occupant is to start the internal application in the electronic device 100 while operating the external application in the second external device 300b will be described.

(1) The process performed when the first occupant starts the internal application in the electronic device 100 while operating the external application in the first external device 300a

The first occupant inputs an instruction for starting the external application by using the operation unit 316 of the first external device 300a. The processing unit 312 starts the external application stored in the storage unit 314 in accordance with the received instruction. As described above, the external application is an application that operates in cooperation with the internal application. Therefore, the external application being executed in the processing unit 312 generates a signal requesting the internal application to be started (hereinafter, referred to as an “execution request”) and outputs the execution request to the first communication unit 310. The execution request includes identification information for identifying the first external device 300a. The first communication unit 310 transmits the execution request to the electronic device 100.

The communication unit 110 of the electronic device 100 receives the execution request from the first external device 300a. The communication unit 110 outputs the received execution request to the processing unit 112. The receiving unit 150 of the processing unit 112 receives the execution request for the internal application from the communication unit 110. This corresponds to receiving the execution request for the internal application from the first external device 300a. The receiving unit 150 outputs the received execution request to the determining unit 152.

The determining unit 152 receives the execution request from the receiving unit 150. The determining unit 152 extracts the identification information from the execution request. The determining unit 152 determines whether the extracted identification information is stored in the storage unit 114. In this example, one or more pieces of identification information are stored in advance in the storage unit 114. The one or more pieces of identification information identify external devices 300 set as communication targets of the internal application for which the receiving unit 150 has received the execution request. Therefore, it can be said that the determining unit 152 determines whether the first external device 300a that has transmitted the execution request is set as a communication target. If the determining unit 152 has determined that the first external device 300a is not set as a communication target, the determining unit 152 terminates the process. In this case, the informing unit 158 may issue a warning (hereinafter, referred to as a “second warning”), and the issuance of the second warning will be described later. Meanwhile, if the determining unit 152 has determined that the first external device 300a is set as a communication target, the determining unit 152 outputs the execution request to the execution controlling unit 156.

When the execution controlling unit 156 has received the execution request from the determining unit 152, the execution controlling unit 156 executes the internal application. The internal application is executed as described above. In this example, the internal application cooperates with the external application in the external device 300 via the communication unit 110. For example, an instruction for the external application input via the operation unit 316 is input to the execution controlling unit 156 via the first communication unit 310 and the communication unit 110, and the internal application executes a process corresponding to the input instruction. In addition, a result from the process executed by the internal application is input to the processing unit 312 via the communication unit 110 and the first communication unit 310, and the external application displays this result on the display unit 318.

(2) The process performed when the second occupant is to start the internal application in the electronic device 100 while operating the external application in the second external device 300b

After (1), the second occupant inputs an instruction for starting the external application by using the operation unit 316 of the second external device 300b. The processing unit 312 starts the external application stored in the storage unit 314 in accordance with the received instruction. The external application being executed in the processing unit 312 generates an execution request and outputs the execution request to the first communication unit 310. The execution request includes identification information for identifying the second external device 300b. The first communication unit 310 transmits the execution request to the electronic device 100.

The communication unit 110 of the electronic device 100 receives the execution request from the second external device 300b. The communication unit 110 outputs the received execution request to the processing unit 112. The receiving unit 150 of the processing unit 112 receives the execution request for the internal application from the communication unit 110. This corresponds to receiving the execution request for the internal application from the second external device 300b. The receiving unit 150 outputs the received execution request to the determining unit 152.

The determining unit 152 receives the execution request from the receiving unit 150. The determining unit 152 extracts the identification information from the execution request.

The determining unit 152 determines whether the extracted identification information is stored in the storage unit 114. This corresponds to determining whether the second external device 300b that has transmitted the execution request is set as a communication target. If the determining unit 152 has determined that the second external device 300b is set as a communication target, the determining unit 152 outputs the execution request to the informing unit 158.

When the informing unit 158 has received the execution request from the determining unit 152, the informing unit 158 causes the display unit 118 to issue a warning (hereinafter, referred to as a “first warning”). At this point, the informing unit 158 may receive information on the external device 300 executing the external application that is cooperating with the internal application from the execution controlling unit 156.

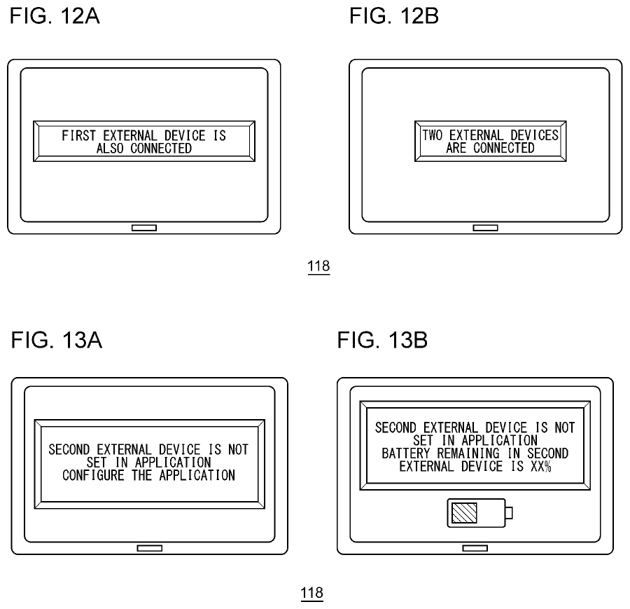

FIGS. 12A and 12B each illustrate a warning to be displayed on the display unit 118. As illustrated in FIG. 12A, the message “First external device is also connected” is displayed.

Referring back to FIG. 11, the informing unit 158 may receive information on the number of external devices 300 for which the execution request has been received from the determining unit 152. As illustrated in FIG. 12B, the message “Two external devices are connected” is displayed. Referring back to FIG. 11, in other words, the informing unit 158 informs the occupants of the number of external devices 300 for which the receiving unit 150 has received the execution request as the first warning. After such a first warning, the informing unit 158 may or may not cause the execution controlling unit 156 to execute the internal application so as to cooperate with the external application in the second external device 300b.

Meanwhile, if the determining unit 152 has determined that the second external device 300b is not set as a communication target, the determining unit 152 terminates the process and causes the informing unit 158 to output a second warning. As the second warning, the informing unit 158 issues a notification prompting the occupant to set the second external device 300b as a communication target. FIGS. 13A and 13B each illustrate another warning to be displayed on the display unit 118. As illustrated in FIG. 13A, the messages “Second external device is not set in application” and “Configure the application” are displayed. Referring back to FIG. 11, the informing unit 158 may receive information on the amount of remaining battery from the second external device 300b via the communication unit 110, the receiving unit 150, and the determining unit 152. When the informing unit 158 issues the second warning described above, the informing unit 158 issues a notification on the amount of remaining battery in the second external device 300b. As illustrated in FIG. 13B, the messages “Second external device is not set in application” and “Battery remaining in second external device is XX %” are displayed.

The above configuration can be implemented in hardware, such as a CPU of a desired computer, a memory, or an LSI, or in software, such as a program loaded on a memory. In this example, the configuration is depicted in the form of functional blocks implemented through cooperation of hardware and software. It is to be understood by a person skilled in the art that these functional blocks can be implemented in various forms solely through hardware or through a combination of hardware and software.

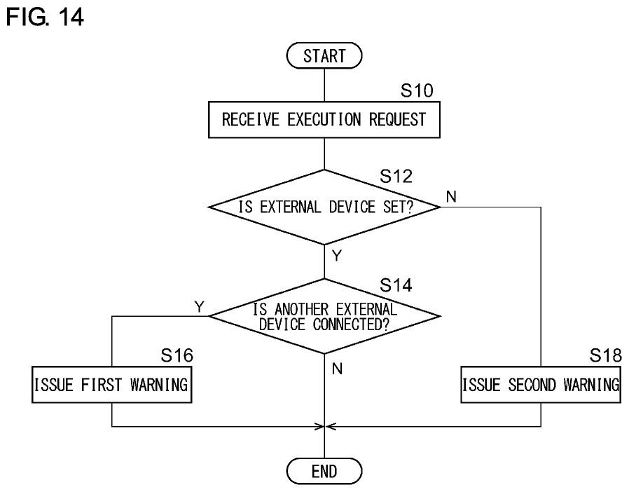

An operation of the electronic device 100 configured as described above will be described. FIG. 14 is a flowchart illustrating a procedure of a process performed by the electronic device 100. The receiving unit 150 receives an execution request (S10). If the external device 300 is set as a communication target (Y in S12), and if another external device 300 is connected (Y in S14), the informing unit 158 issues the first warning (S16). If no other external device 300 is connected (N in S14), step 16 is skipped. If the external device 300 is not set as a communication target (N in S12), the informing unit 158 issues the second warning (S18).

According to the present embodiment, a warning is issued if an execution request is received from the second external device 300b while the internal application is being executed for the first external device 300a. This allows the occupants to recognize the connection of a plurality of external devices 300 to the electronic device 100. Allowing the occupants to recognize the connection of a plurality of external devices 300 to the electronic device 100 helps reduce the risk of interrupting the internal application being executed or the external application being executed. In addition, allowing the occupants to recognize the connection of a plurality of external devices 300 to the electronic device 100 helps reduce the risk of stopping the internal application being executed or the external application being executed. Furthermore, allowing the occupants to recognize the connection of a plurality of external devices 300 to the electronic device 100 helps reduce the risk of interfering with the internal application being executed or the external application being executed. Informing the occupants of the number of external devices 300 for which the execution request has been received allows the occupants to recognize the number of external devices 300 for which the execution request has been received.

### Embodiment 4

Next, Embodiment 4 will be described. As with Embodiment 3, Embodiment 4 relates to an electronic device 100 to be mounted in a vehicle 10. In addition, Embodiment 4 relates to a case in which the electronic device 100 receives an execution request from an external application in a second external device 300b while an internal application in the electronic device 100 and an external application in a first external device 300a are operating in cooperation with each other. Embodiment 4 differs from Embodiment 3 in the content of a first warning. In this respect, Case 1 to Case 6 will be described below in sequence. Configurations of the vehicle 10, the electronic device 100, the first external device 300a, and the second external device 300b according to Embodiment 4 are similar to those illustrated in FIG. 1 or 11. The description below centers on the differences from the foregoing.

(Case 1)

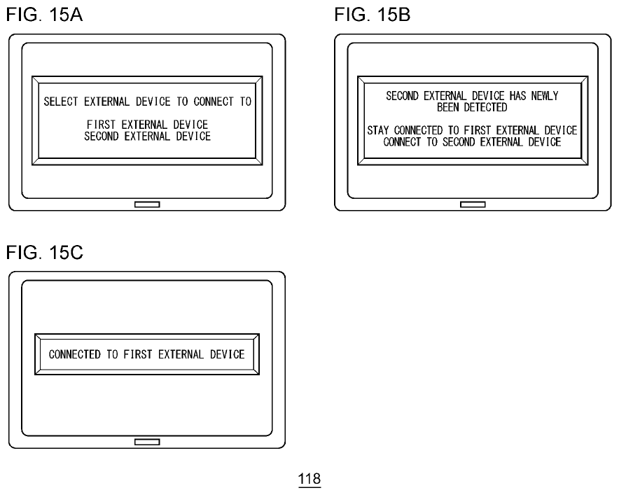

When the informing unit 158 has received an execution request from the determining unit 152, the informing unit 158 inquires the execution controlling unit 156 of an external device 300 that is already connected. The informing unit 158 is informed by the execution controlling unit 156, for example, that the first external device 300a is connected. Then, the informing unit 158 issues, as a first warning, a notification prompting an occupant to select either one of the first external device 300a and the second external device 300b. FIGS. 15A to 15C each illustrate a warning to be displayed on the display unit 118. As illustrated in FIG. 15A, the messages “Select external device to connect to,” “First external device,” and “Second external device” are displayed.

Referring back to FIG. 11, if a first occupant or a second occupant (hereinafter, referred to as an “occupant”) is to select the first external device 300a, the occupant selects the first external device 300a by operating the operation unit 116. In accordance with the selection, the execution controlling unit 156 keeps the connection to the first external device 300a and refrains from connecting to the second external device 300b. Meanwhile, if the occupant is to select the second external device 300b, the occupant selects the second external device 300b by operating the operation unit 116. In accordance with the selection, the execution controlling unit 156 disconnects the connection to the first external device 300a and connects to the second external device 300b.

In this example, in place of the message in FIG. 15A, the messages “Second external device has newly been detected, ” “Stay connected to first external device,” and “Connect to second external device” may be displayed, as illustrated in FIG. 15B. The process that follows thereafter is as described above, and thus descriptions thereof will be omitted. Although the first external device 300a and the second external device 300b are indicated in FIGS. 15A and 15B, a third external device 300c and so on may also be displayed.

(Case 2)

When the informing unit 158 has received an execution request from the determining unit 152, the informing unit 158 inquires the execution controlling unit 156 of information on the last-connected external device 300. The informing unit 158 is informed by the determining unit 152, for example, that the electronic device 100 connected to the first external device 300a last time. Then, the informing unit 158 issues, as a first warning, a notification for informing that the electronic device 100 will connect to the last-connected one of the first external device 300a and the second external device 300b. As illustrated in FIG. 15C, the message “Connected to first external device” is displayed. Referring back to FIG. 11, if the informing unit 158 has been informed by the execution controlling unit 156 that the electronic device 100 connected to the second external device 300b last time, the informing unit 158 displays the message “Connected to second external device.” Then, the execution controlling unit 156 connects to the last-connected external device 300.

(Case 3)

In the foregoing cases, the second occupant inputs an instruction for starting the external application by operating the operation unit 316 of the second external device 300b, and the processing unit 312 then starts the external application. Alternatively, the processing unit 312 may start the external application upon the second communication unit 320 of the second external device 300b receiving an incoming call. Thereafter, as in the foregoing cases, the external application being executed in the processing unit 312 generates an execution request and outputs the execution request to the first communication unit 310. For example, this external application and the internal application that is requested to be executed through the electronic device 100 correspond to an application related to a voice call. The electronic device 100 executes a process similar to those in the foregoing cases on the stated execution request.

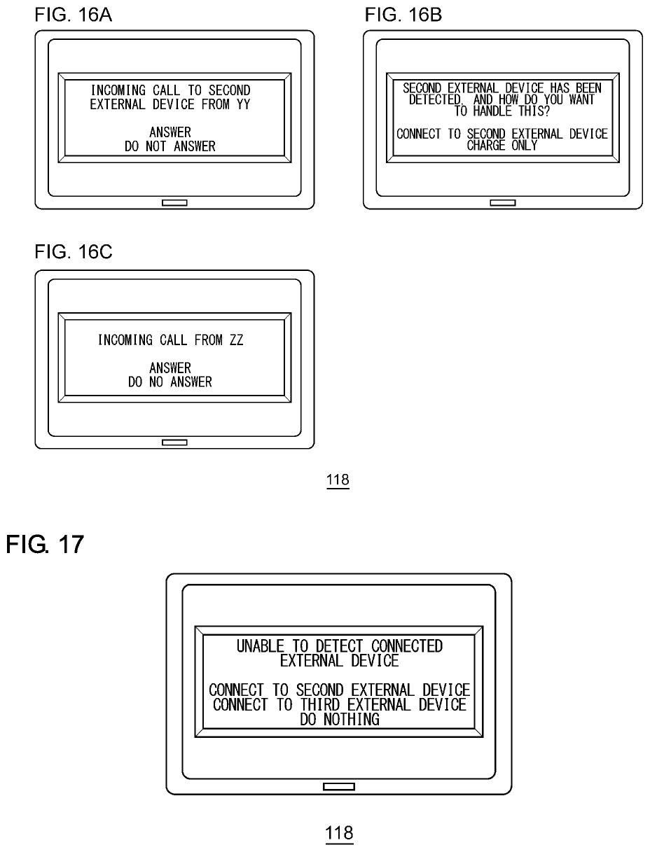

FIGS. 16A to 16C each illustrate another warning to be displayed on the display unit 118. As illustrated in FIG. 16A, the messages “Incoming call to second external device from YY,” “Answer,” and “Do not answer” are displayed. Referring back to FIG. 11, in this manner, the informing unit 158 issues, as a first warning, a notification prompting an occupant to select whether to execute the internal application that operates in cooperation with the external application executed in the second external device 300b. If the occupant is to answer the call, the occupant selects “Answer” by operating the operation unit 116. In accordance with the selection, the execution controlling unit 156 connects to the second external device 300b. Meanwhile, if the occupant is not to answer the call, the occupant selects “Do not answer” by operating the operation unit 116. In accordance with the selection, the execution controlling unit 156 refrains from connecting to the second external device 300b.

(Case 4)

When the second external device 300b and the electronic device 100 are connected to each other not via wireless communication but via a Universal Serial Bus (USB) cable, the processing unit 312 of the second external device 300b may start the external application. Thereafter, as in the foregoing cases, the external application being executed in the processing unit 312 generates an execution request and outputs the execution request to the first communication unit 310. The electronic device 100 executes a process similar to those in the foregoing cases on the stated execution request.

As illustrated in FIG. 16B, the messages “Second external device has been detected, and how do you want to handle this?,” “Connect to second external device,” and “Charge only” are displayed. Referring back to FIG. 11, in this manner, the informing unit 158 issues, as a first warning, a notification prompting an occupant to select whether to execute the internal application that operates in cooperation with the external application executed in the second external device 300b or to charge the second external device 300b. If the electronic device 100 is to be connected to the second external device 300b, the occupant selects “Connect to second external device” by operating the operation unit 116. In accordance with the selection, the execution controlling unit 156 connects to the second external device 300b. Meanwhile, if the occupant is to charge the second external device 300b, the occupant selects “Charge only” by operating the operation unit 116. In accordance with the selection, the execution controlling unit 156 only charges the second external device 300b without connecting to the second external device 300b.

(Case 5)

When there is an incoming call to the first external device 300a while the first external device 300a and the second external device 300b are connected to the electronic device 100, the message such as the one illustrated in FIG. 16C may be displayed. In this example, the messages “Answer” and “Do not answer” are displayed.

(Case 6)

Referring back to FIG. 11, in the situation assumed in this case, the first external device 300a to the third external device 300c are present in the vehicle 10, and the external application in the first external device 300a and the internal application in the electronic device 100 operate in cooperation with each other. Meanwhile, neither the external application in the second external device 300b nor the external application in the third external device 300c cooperates with the internal application in the electronic device 100. However, the electronic device 100 recognizes the presence of the second external device 300b and the third external device 300c in a wireless communication layer. In other words, the communication unit 110 of the electronic device 100 can communicate with the first external device 300a to the third external device 300c. The execution controlling unit 156 executes the internal application that operates in cooperation with the external application executed in the first external device 300a via the communication unit 110.

In such a situation, upon the first occupant carrying the first external device 300a getting off the vehicle 10, the communication unit 110 of the electronic device 100 detects the disconnection of the communication with the first external device 300a. The communication unit 110 notifies the execution controlling unit 156 of the disconnection and outputs information on the second external device 300b and the third external device 300c with which the electronic device 100 can communicate to the informing unit 158 via the execution controlling unit 156. Thereafter, the informing unit 158 issues a notification prompting an occupant to select whether to execute the internal application that operates in cooperation with the external application executed in the second external device 300b or to execute the internal application that operates in cooperation with the external application executed in the third external device 300c. FIG. 17 illustrates yet another warning to be displayed on the display unit 118. The messages “Unable to detect connected external device,” “Connect to second external device,” “Connect to third external device,” and “Do nothing” are displayed.

Referring back to FIG. 11, if the electronic device 100 is to be connected to the second external device 300b, the occupant selects “Connect to second external device” by operating the operation unit 116. In accordance with the selection, the execution controlling unit 156 connects to the second external device 300b. If the electronic device 100 is to be connected to the third external device 300c, the occupant selects “Connect to third external device” by operating the operation unit 116.

In accordance with the selection, the execution controlling unit 156 connects to the third external device 300c. If the electronic device 100 is to be connected to neither the second external device 300b nor the third external device 300c, the occupant selects “Do nothing” by operating the operation unit 116. In accordance with the selection, the execution controlling unit 156 terminates the internal application.

According to the present embodiment, issuing a notification prompting an occupant to select either the first external device 300a or the second external device 300b allows the occupant to select either one of the external devices 300. Issuing a notification informing an occupant that the electronic device 100 is to be connected to the last-connected external device 300 allows the occupant to recognize the connection to the last-connected external device 300. Issuing a notification prompting an occupant to select whether to execute the internal application allows the occupant to select whether to execute the internal application. Issuing a notification prompting an occupant to select whether to execute the internal application or to charge the external device 300 allows the occupant to select whether to execute the internal application or to charge the external device 300. Issuing a notification prompting an occupant to set the second external device 300b as a communication target allows the occupant to set the second external device 300b as a communication target. Issuing a notification on the amount of remaining battery allows the occupant to recognize the amount of remaining battery. Issuing a notification prompting an occupant to select the second external device 300b or the third external device 300c when the disconnection of the communication with the first external device 300a is detected allows the communication to be taken over.

An overview of one aspect of the present disclosure is as follows. An electronic device according to one aspect of the present disclosure is capable of executing an internal application that operates in cooperation with an external application executed in an external device. The electronic device includes a receiving unit that receives an execution request for the internal application from the external device, a determining unit that determines whether the external device that has transmitted the execution request is set as a communication target of the internal application for which the receiving unit has received the execution request, a verifying unit that verifies a version of the external application executed in the external device if the determining unit has determined that the external device is set as the communication target, an execution controlling unit that executes the internal application if the version verified by the verifying unit is no earlier than a threshold, and an informing unit that issues a warning if the version verified by the verifying unit is older than the threshold.

According to this aspect, if the external device is set as a communication target, and if the version of the external application is older than the threshold, a warning is issued.

This makes it possible to ensure the reliability and to allow for an easy operation at the same time when connecting the two applications.

The informing unit may issue a warning indicating that a connection cannot be established. In this case, issuing a warning indicating that the connection cannot be established allows an occupant to be informed that the connection cannot be established.

The informing unit may issue a warning indicating that one or more functions of the internal application are unavailable. In this case, issuing a warning indicating that one or more functions of the internal application are unavailable allows an occupant to be informed that one or more functions of the internal application are unavailable.

The informing unit may issue a warning prompting for an upgrade of the external application. In this case, issuing a warning prompting for an upgrade of the external application allows an occupant to upgrade the external application more easily.

The informing unit may change the content of a warning in accordance with a difference between the version verified by the verifying unit and the threshold. In this case, changing the content of the warning in accordance with a difference between the version and the threshold allows an occupant to be informed how old the version is.

The electronic device may further include a communication unit that executes communication with the external device. The communication unit, if a communication quality through a first communication circuit has deteriorated, may make a switch to a second communication circuit different from the first communication circuit. In this case, if the communication quality through the first communication circuit has deteriorated, the communication circuit is switched from the first communication circuit to the second communication circuit. This allows the cooperation of the two applications to continue even when the communication quality has deteriorated.

Another aspect of the present disclosure provides also an electronic device. The electronic device is capable of executing an internal application that operates in cooperation with an external application executed in an external device. The electronic device includes a receiving unit that receives an execution request for the internal application from a first external device, a determining unit that determines whether the first external device that has transmitted the execution request is set as a communication target of the internal application for which the receiving unit has received the execution request, a verifying unit that verifies with a second external device set as the communication target whether the electronic device may communicate with the first external device if the determining unit has determined that the first external device is not set as the communication target, and an execution controlling unit that executes the internal application if the verifying unit has verified that the electronic device may communicate with the first external device.

According to this aspect, when it has been determined that the first external device is not set as a communication target, the electronic device verifies with the second external device set as a communication target whether the electronic device may communicate with the first external device. This makes it possible to ensure the reliability and to allow for an easy operation at the same time.

The second external device requested for a verification by the verifying unit may respond whether the electronic device may communicate with the first external device on the basis of a setting in the external application in the second external device. In this case, the second external device responds whether the electronic device may communicate with the first external device on the basis of the setting in the external application. This makes it possible to ensure the reliability and to allow for an easy operation at the same time.

The second external device requested for a verification by the verifying unit may respond whether the electronic device may communicate with the first external device on the basis of a setting in an application other than the external application in the second external device. In this case, the second external device responds whether the electronic device may communicate with the first external device on the basis of the setting in an application other than the external application. This makes it possible to ensure the reliability and to allow for an easy operation at the same time.

The electronic device may further include a communication unit that executes communication with the first external device and the second external device. The communication unit, if a communication quality through a first communication circuit has deteriorated, may make a switch to a second communication circuit different from the first communication circuit. In this case, if the communication quality through the first communication circuit has deteriorated, the communication circuit is switched from the first communication circuit to the second communication circuit. This allows the cooperation of the two applications to continue even when the communication quality has deteriorated.

Yet another aspect of the present disclosure provides a processing method. This is a processing method to be performed in an electronic device capable of executing an internal application that operates in cooperation with an external application executed in an external device. The processing method includes receiving an execution request for the internal application from the external device, determining whether the external device that has transmitted the execution request is set as a communication target of the internal application for which the execution request has been received, verifying aversion of the external application executed in the external device if it has been determined that the external device is set as the communication target, executing the internal application if the verified version is no earlier than a threshold, and issuing a warning if the verified version is older than the threshold.

An overview of one aspect of the present disclosure is as follows. An electronic device 100 according to one aspect of the present disclosure is capable of executing an internal application that operates in cooperation with an external application executed in an external device 300. The electronic device 100 includes a receiving unit 150 that receives an execution request for the internal application from a first external device 300, a determining unit 152 that determines whether the first external device 300 that has transmitted the execution request is set as a communication target of the internal application for which the receiving unit 150 has received the execution request, an execution controlling unit 156 that executes the internal application if the determining unit 152 has determined that the first external device 300 is set as a communication target, and an informing unit 158 that issues a warning if the receiving unit 150 has received an execution request for the internal application from a second external device 300 and the determining unit 152 has determined that the second external device 300 is set as a communication target while the execution controlling unit 156 is executing the internal application in response to the execution request from the first external device 300.

According to this aspect, a warning is issued if an execution request is received from the second external device 300 while the internal application is being executed for the first external device 300. This allows an occupant to recognize connections of a plurality of external devices 300 to the electronic device 100.

The informing unit 158 may issue, as the warning, the number of external devices 300 for which the receiving unit 150 has received an execution request. In this case, informing an occupant of the number of external devices 300 for which the execution request has been received allows the occupant to recognize the number of external devices 300 for which the execution request has been received.

The informing unit 158 may issue, as the warning, a notification prompting an occupant to select one of the first external device 300 and the second external device 300. In this case, issuing a notification prompting an occupant to select one of the first external device 300 and the second external device 300 allows the occupant to select one of the external devices 300.

The informing unit 158 may issue, as the warning, a notification informing an occupant that the electronic device 100 is to be connected to a last-connected one of the first external device 300 or the second external device 300. In this case, issuing a notification informing an occupant that the electronic device 100 is to be connected to the last-connected external device 300 allows the occupant to recognize the connection to the last-connected external device 300.

The informing unit 158 may issue, as the warning, a notification prompting an occupant to select whether to execute the internal application that operates in cooperation with the external application executed in the second external device 300. In this case, issuing a notification prompting an occupant to select whether to execute the internal application allows the occupant to select whether to execute the internal application.

The informing unit 158 may issue, as the warning, a notification prompting an occupant to select whether to execute the internal application that operates in cooperation with the external application executed in the second external device 300 or to charge the second external device 300. In this case, issuing a notification prompting an occupant to select whether to execute the internal application or to charge the second external device 300 allows the occupant to select whether to execute the internal application or to charge the second external device 300.

The informing unit 158 may issue a notification prompting an occupant to set the second external device 300 as a communication target if the determining unit 152 has determined that the second external device 300 is not set as a communication target. In this case, issuing a notification prompting an occupant to set the second external device 300 as a communication target allows the occupant to set the second external device 300 as a communication target.

The informing unit 158 may issue a notification on an amount of remaining battery in the second external device 300. In this case, issuing a notification on the amount of remaining battery allows the occupant to recognize the amount of remaining battery.

Another aspect of the present disclosure provides also an electronic device 100. The electronic device 100 includes a communication unit 110 capable of communicating with a first external device 300, a second external device 300, and a third external device 300; an execution controlling unit 156 that executes an internal application that operates in cooperation with an external application executed in the first external device 300 via the communication unit 110; and an informing unit 158 that, if the communication unit 110 has detected a disconnection of a communication with the first external device 300, issues a notification prompting an occupant to select whether to execute an internal application that operates in cooperation with an external application executed in the second external device 300 or to execute an internal application that operates in cooperation with an external application executed in the third external device 300.

According to this aspect, if the disconnection of the communication with the first external device 300 is detected, a notification prompting an occupant to select the second external device 300 or the third external device 300 is issued. This allows the communication to be taken over.

Yet another aspect of the present disclosure provides a processing method. This is a processing method to be performed in an electronic device 100 capable of executing an internal application that operates in cooperation with an external application executed in an external device 300. The processing method includes receiving an execution request for the internal application from a first external device 300, determining whether the first external device 300 that has transmitted the execution request is set as a communication target of the internal application for which the execution request has been received, executing the internal application if it has been determined that the first external device 300 is set as a communication target, and issuing a warning if an execution request for the internal application is received from a second external device 300 and if it has been determined that the second external device 300 is set as a communication target while the internal application is being executed in response to the execution request from the first external device 300.

Thus far, the present disclosure has been described through the embodiments. These embodiments are illustrative in nature, and it should be appreciated by a person skilled in the art that various modifications can be made to the combinations of the constituent elements and the processing processes and that such modifications also fall within the scope of the present disclosure.

In Embodiments 1 and 2, an upgrade is executed upon an occupant's acknowledgement. Alternatively, an upgrade may be executed automatically. In Embodiments 1 and 2, an upgrade instruction is output from the electronic device 100 to the external device 300. Alternatively, an upgrade instruction may be output from the external device 300 to the electronic device 100.

In Embodiments 3 and 4, the informing unit 158 displays the first warning and the second warning on the display unit 118 of the electronic device 100. This is not a limiting example, and the informing unit 158 may display the first warning and the second warning on the display unit 318 of the external device 300 via the communication unit 110, the first communication unit 310, and the processing unit 312, for example. This modification helps improve the flexibility in the configuration.

In Embodiments 3 and 4, the informing unit 158 displays the first warning and the second warning on the display unit 118 of the electronic device 100. This is not a limiting example, and the informing unit 158 may output the first warning and the second warning through a loudspeaker in the form of an audio message. This modification helps improve the flexibility in the configuration.

Any desired combinations of Embodiments 1 to 4 are also valid. This modification helps obtain an effect through the desired combinations.

While various embodiments have been described herein above, it is to be appreciated that various changes in form and detail may be made without departing from the spirit and scope of the invention (s) presently or hereafter claimed.

### CROSS-REFERENCE TO RELATED APPLICATIONS

This application is based upon and claims the benefit of priority from the prior Japanese Patent Application No. 2019-34462, filed on Feb. 27, 2019, and prior Japanese Patent Application No. 2019-34463, filed on Feb. 27, 2019, the entire contents of which are incorporated herein by reference.

What is claimed is:

1. An electronic device capable of executing an internal application that operates in cooperation with an external application executed in an external device, the electronic device comprising:
a receiving unit that receives an execution request for the internal application from the external device;
a determining unit that determines whether the external device that has transmitted the execution request is set as a communication target of the internal application for which the receiving unit has received the execution request;
a verifying unit that verifies a version of the external application executed in the external device if the determining unit has determined that the external device is set as the communication target;
an execution controlling unit that executes the internal application if the version verified by the verifying unit is no earlier than a threshold; and
an informing unit that issues a warning if the version verified by the verifying unit is older than the threshold.

2. The electronic device according to claim 1, wherein the informing unit issues a warning indicating that a connection cannot be established.

3. The electronic device according to claim 1, wherein the informing unit issues a warning indicating one or more functions of the internal application are unavailable.

4. The electronic device according to claim 1, wherein the informing unit issues a warning prompting for an upgrade of the external application.

5. The electronic device according to claim 1, wherein the informing unit changes a content of the warning in accordance with a difference between the version verified by the verifying unit and the threshold.

6. The electronic device according to claim 1, further comprising:
a communication unit that executes communication with the external device, wherein
the communication unit, if a communication quality through a first communication circuit has deteriorated, makes a switch to a second communication circuit different from the first communication circuit.

7. An electronic device capable of executing an internal application that operates in cooperation with an external application executed in an external device, the electronic device comprising:
a receiving unit that receives an execution request for the internal application from a first external device;
a determining unit that determines whether the first external device that has transmitted the execution request is set as a communication target of the internal application for which the receiving unit has received the execution request;
a controlling unit that executes the internal application if the determining unit has determined that the first external device is set as the communication target; and
an informing unit that issues a warning if the receiving unit has received an execution request for the internal application from a second external device and if the determining unit has determined that the second external device is set as the communication target while the controlling unit is executing the internal application in response to the execution request from the first external device.

8. The electronic device according to claim 7, wherein the informing unit issues, as the warning, the number of external devices for which the receiving unit has received an execution request.

9. The electronic device according to claim 7, wherein the informing unit issues, as the warning, a notification prompting a user to select one of the first external device and the second external device.

10. The electronic device according to claim 7, wherein the informing unit issues, as the warning, a notification informing that the electronic device is to be connected to a last-connected one of the first external device and the second external device.

11. The electronic device according to claim 7, wherein the informing unit issues, as the warning, a notification prompting a user to select whether to execute the internal application that operates in cooperation with the external application executed in the second external device.

12. The electronic device according to claim 7, wherein the informing unit issues, as the warning, a notification prompting a user to select whether to execute the internal application that operates in cooperation with the external application executed in the second external device or to charge the second external device.

13. The electronic device according to claim 7, wherein the informing unit issues a notification prompting a user to set the second external device as the communication target if the determining unit has determined that the second external device is not set as the communication target.

14. The electronic device according to claim 13, wherein the informing unit issues a notification on an amount of remaining battery in the second external device.
